(19) United States
(12) Patent Application Publication
(10) Pub. No.: US 2020/0210030 A1
(43) Pub. Date: Jul. 2, 2020

(54) TRANSLATING TEXT IN USER INTERFACES BASED ON USER INTERFACE CONTEXTS

(71) Applicant: MICRO FOCUS LLC, Santa Clara, CA (US)

(72) Inventors: Yi-Qun Ren, SHAGHAI (CN); KAI HU, SHAGHAI (CN); JIAN-MIN GAO, SHAGHAI (CN); URIEL LUSTIG, YEHUD (CN)

(21) Appl. No.: 16/632,423

(22) PCT Filed: Aug. 28, 2017
(86) PCT No.: PCT/CN2017/099239

§ 371 Date: Jan. 20, 2020

(51) Int. Cl. G06F 3/0482; G06F 40/47; G06F 40/166

(52) U.S. Cl. CPC G06F 3/0482; G06F 40/166; G06F 40/47

(57) ABSTRACT

In some examples, a system receives a user interface (UI) context of a UI, the UI context identifying a relationship between UI elements of the UI, and translates, based on the identified relationship between the UI elements in the UI context, text in the UI from a first language to a second language.

### BACKGROUND

A user interface (UI) of a program can include UI elements. A UI element can include text to provide an indication of a function of the UI element, or to convey information to a user of the UI. Target users of programs may reside in different countries that speak different languages. Accordingly, different versions of the UI with different languages are provided with the programs in the different countries.

### BRIEF DESCRIPTION OF THE DRAWINGS

Some implementations of the present disclosure are described with respect to the following figures.

FIG. 1 is a flow diagram of a UI translation process according to some examples.

FIGS. 2 and 3 illustrate different UI arrangements containing text that can be translated by techniques or mechanisms according to some examples.

FIG. 4 is a block diagram of a system that includes a UI translation engine to translate text in a UI, according to some examples.

FIG. 5 is a block diagram of a system including a machine translator according to further examples.

FIG. 6 is a block diagram of a storage medium storing machine-readable instructions according to additional examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A program can refer to any collection of machine-readable instructions (e.g., software or firmware) that can execute in a computer system to perform various tasks. The program may be initially developed in a first language (e.g., English). As a result, text in user interfaces (UIs) of the program may be in the first language. A UI can refer to any displayable collection of information and/or control elements that can be viewed by a user.

The term “language” refers to the words, their pronunciation, and methods of combining the words as understood by a human community. Examples of different languages include English, Mandarin, Spanish, French, German, and so forth. After the initial development of the program, program developers may wish to produce UIs of the program in a second language (or multiple other languages) that is (are) different from the first language.

In scenarios where text in a document is to be translated from one language to another language, machine translators can be used to translate words of the document between the languages. A “document” can refer to any collection of words that are arranged in paragraphs, sentences, or other segments. How the words are used in relation to other words in the document can provide a context to aid a machine translator in translating the document.

However, such machine translators may not accurately produce translations when applied to text in a UI of a program. Words presented in the UI are often isolated words that are not used in complete sentences or in paragraphs or other segments. As a result, document-based contexts available to translations of documents are not available when translating the text of a UI. Therefore, applying document machine translators to translate UI text can produce inaccurate results. A word can have multiple different possible meanings. Without proper context, a machine translator can pick the wrong meaning for translation of the UI text.

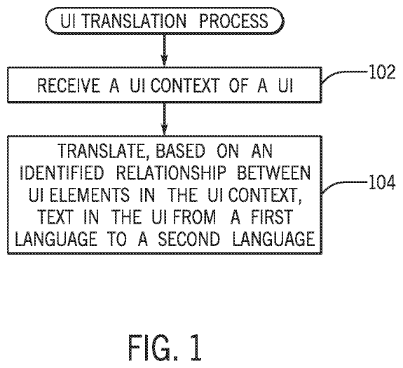

In accordance with some implementations of the present disclosure, as shown in FIG. 1, a UI translation process includes receiving (at 102) a UI context of a UI. The UI context identifies relationships among UI elements of the UI.

The UI translation process further includes translating (at 104), based on an identified relationship between UI elements in the UI context, text in the UI from a first language to a second language different from the first language.

The relationships between UI elements of a UI can include a hierarchical relationship in which UI elements within a given set of UI elements can be related to one another as parents and children or as siblings. Although in some examples sibling UI elements can be considered as being part of a hierarchical relationship, it is noted that in other examples, sibling UI elements are related at the same level and thus do not have to be considered as having a hierarchical relationship. An example of a parent-child relationship can be one where a first UI element represents a more general category and a second UI element represents a more specific category that is contained within the general category. For example, a first UI element can be a File menu element, which represents a File menu that has multiple sub-menu items. Under the File menu, a first sub-menu item can be an Open menu item, to open a document for example. A second sub-menu item in the File menu can be a New item to create a new document. A third sub-menu item in the File menu can be a Save menu item, to save changes made to the document. In this example, the Open sub-menu item, the New sub-menu item, and the Save sub-menu item are child UI elements of the parent File menu item. Moreover, the Open sub-menu item, New sub-menu item, and Save sub-menu item are siblings of one another.

Although reference is made to specific example menu items, it is noted that in other examples, other types of menu items are contemplated.

The foregoing example refers to a hierarchical relationship that includes a parent UI element and child UI elements (part of a parent-child relationship between UI elements). In other examples, a hierarchical arrangement can include more than two levels of UI elements, such that a grandparent level that includes a UI element (or multiple UI elements), a parent level that includes UI element(s) depending from the UI element(s) at the grandparent level, and a child level that includes UI element(s) depending from the UI element(s) at the parent level.

The foregoing refers to a hierarchical relationship of UI elements where a UI element of a more general category includes UI elements of a more specific category. In further examples, the hierarchical arrangement can be a spatial hierarchical arrangement, in which a first UI element that is displayed by a UI can spatially contain other UI elements. In other words, the first UI element has a region in the UI that is large enough to contain regions corresponding to other UI elements. This is an example of a containment type relationship between UI elements.

Another type of a spatial relationship is a proximity relationship between UI elements. For example, a first UI element and a second UI element that are within a specified distance of one another can be considered to have a proximity relationship. Alternatively, a collection of UI elements that are closer to one another than to other UI elements of a UI can be considered to have a proximity relationship with one another.

The relationships of the UI elements in the UI context can be part of a UI structure that is defined by a UI definition. A UI definition can define UI elements using program code or a markup language (such as an eXtensible Markup Language (XML) or another markup language). In other examples, the UI definition can include different information to define the UI elements that are to be presented by a UI.

A program can have multiple UIs defined by respective UI definitions, which can be in the form of a UI definition file or other UI definition information. Each UI of the program has a set of UI elements that contain respective text to be translated by the UI translation process according to some implementations of the present disclosure.

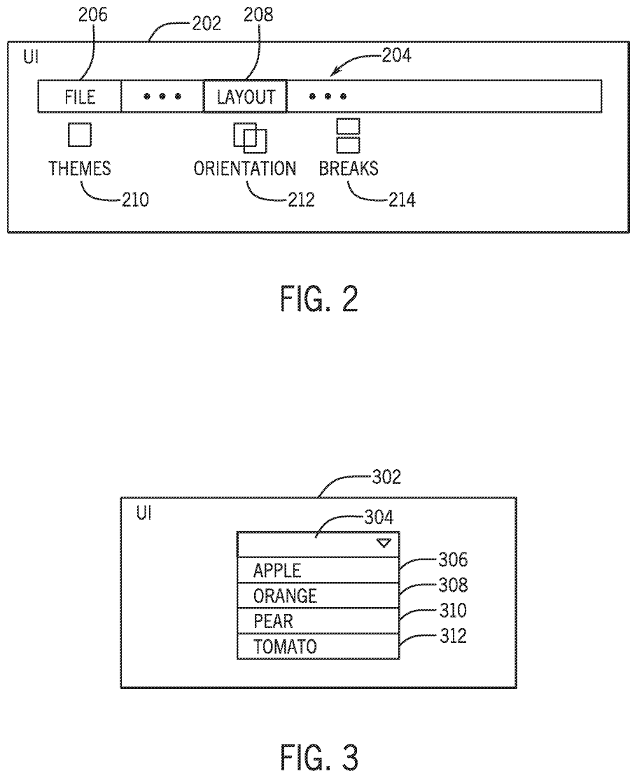

FIG. 2 shows an example of a UI 202, which includes a menu bar 204. The menu bar 204 has menu items 206 and 208, where the menu item 206 is a File menu item, and the menu item 208 is a Layout menu item. The menu items 206 and 208 are examples of higher level UI elements in a hierarchical arrangement.

In the example of FIG. 2, it is assumed that the Layout menu item 208 has been selected, which causes various sub-menu items 210, 212, and 214 to be displayed. The sub-menu item 210 is a Themes sub-menu item, the sub-menu item 212 is an Orientation sub-menu item, and the sub-menu item 212 is a Breaks sub-menu item. In the example of FIG. 2, the menu items 206 and 208 that are part of the menu bar 204 are more general menu items, and each general menu item can include sub-menu items that are considered to be children UI elements of the more general menu item.

In FIG. 2, the following are text items in the UI 202 that are to be translated: File, Layout, Themes, Orientation, and Breaks. If the foregoing words are considered in isolation, it can be difficult for a machine translator to translate some of the text items. For example, the text “Orientation” can have several meanings. In a first context, “Orientation” can refer to a portrait orientation or a landscape orientation of a page to be displayed by a program. In another context, “Orientation” can refer to a geographic orientation, such as east, west, south, and north. In a further context, “Orientation” can refer to basic beliefs or feelings about a particular subject by a person. Without the proper context, the machine translator can select the wrong meaning of the text “Orientation” for translation.

Similarly, the text “Breaks” can have different meanings in different contexts. In a first context, “Breaks” can refer to a physical object suffering damage by separating. In a second context, “Breaks” can refer to a page break or section break between different parts of a document produced by a program.

In accordance with some implementations of the present disclosure, the UI translation process is able to detect a relationship between the Orientation sub-menu item 212 and its parent Layout menu item 208. Based on this detected parent-child relationship between the Layout menu item 208 and the Orientation sub-menu item 212, the UI translation process is able to determine that the intended meaning of the text “Orientation” in the UI 202 is that of the orientation of a displayed page, such as a portrait orientation or a landscape orientation. This determination is based on understanding that the Orientation sub-menu item 212 is a more specific category covered by the general category represented by the Layout menu item 208 that is used to define layouts of displayed pages.

FIG. 3 shows another example UI 302 that includes a dropdown list 304. Selection of the dropdown list 304 can cause the following sub-items to be displayed: an Apple sub-item 306, an Orange sub-item 308, a Pear sub-item 310, and a Tomato sub-item 312. The text “Orange” can mean either the color orange or a fruit. To properly translate the text in the dropdown list 304, the UI translation process considers the UI context of the dropdown list, which in this example includes sibling relationships among the sub-items 306, 308, 310, and 312. Since the sibling sub-items 306, 310, and 312 each refers to a respective fruit, the UI translation process is able to determine that the meaning of “Orange” is the fruit rather than the color.

In other examples, a spatial relationship identified by a UI context can include a spatial containment relationship or a proximity relationship between UI elements of a set of UI elements. For example, a first UI element may be closer to a second UI element than to a third UI element in the UI. The UI translation process can use the fact that the first UI element is closer to the second UI element to aid the UI translation process in translating the text in the first and/or second UI element. As another example, the UI translation process can use the fact that a first UI element spatially contains a second UI element to aid the UI translation process in translating the text in the first and/or second UI element.

Based on the UI context, the UI translation process can also determine the type of UI element. For example, a first type of UI element is a menu-type UI element (such as shown in FIG. 2) that is either a more general menu item or a sub-menu item. As another example, another type of UI element is a list-type UI element (such as shown in FIG. 3), which is associated with a list of sub-items in a list. Depending upon the determined type of UI element, the UI translation process can determine how to translate the text of a UI element based on relationships with other UI element(s).

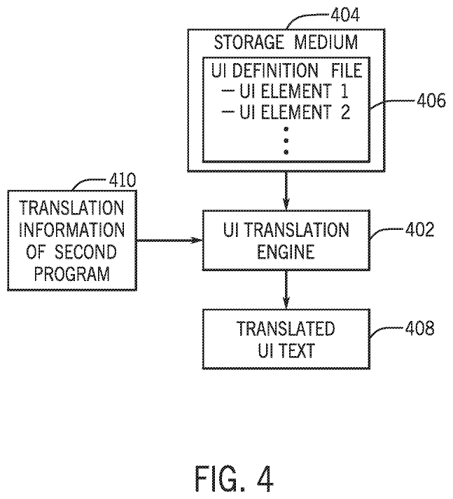

FIG. 4 is a block diagram of an example system that includes a UI translation engine 402 according to some implementations of the present disclosure. The UI translation engine 402 is a machine translator that is used to perform translation of text in a UI between different languages. For example, the UI translation engine 402 can perform the UI translation process of FIG. 1, or another UI translation process according to some implementations of the present disclosure.

As used here, the term “engine” can refer to a hardware processing circuit, such as any or some combination of the following: a microprocessor, a core of a multi-core microprocessor, a microcontroller, a programmable gate array, a programmable integrated circuit device, or any other type of hardware processing circuit. In further examples, an “engine” can refer to a combination of a hardware processing circuit and machine-readable instructions executable on the hardware processing circuit.

A “system” can refer to a computer or an arrangement of multiple computers. A computer can refer to a notebook computer, a desktop computer, a server computer, a tablet computer, a smartphone, or any other type of electronic device. In some examples, the system of FIG. 4 can represent a system that is used by a program developer.

The system of FIG. 4 also includes a storage medium 404, which stores a UI definition file 406 for defining UI elements to be used in a UI. Although just one UI definition file is depicted in FIG. 4, it is noted that the storage medium 404 can store multiple UI definition files for defining different sets of UI elements of a UI.

Based on the UI definition file 406, the UI translation engine 402 is able to determine the UI context of UI elements displayed by the UI. Based on the UI context, the UI translation engine 402 is able to translate text in the UI elements from a first language to a second language different from the first language. Although reference is made to translations between just first and second languages, it is noted that in other examples, translations can be performed among more than two different languages.

In some examples, the UI definition file 406 defines UI elements for a first program, such as a program that is under development or a program designed for a first language that is to be tailored to a second language.

To aid the UI translation engine 402 in translating the text of UI elements defined by the UI definition file 406, the UI translation engine 402 can further receive translation information of a second program that is different from the first program. The translation information of the second program includes translations of text in UI elements of the second program between different languages. The second program may be one where UI text has already been translated between different languages. The translation information 410 of the already translated UI text can be used to aid the UI translation engine 402 in translating the UI text for the first program between different languages.

Although the second program may be a program that is different from the first program, the second program may have at least a subset of UI elements with similar UI structures as corresponding UI elements of the first program. For example, the second program can include a menu bar having menu items that are similar to menu items of a menu bar of the first program, and the second program can have sub-menu items of the menu items in the menu bar that are similar to sub-menu items of the first program.

Similarity of UI elements can refer to UI elements that share a similar hierarchical arrangement, and that include similar text. Similar text can refer to text that are identical or that differ in some aspect but is intended to have a same meaning. For example, an Orientation menu item for the first program can be considered to be similar to an Orient menu item for the second program, since “Orient” and “Orientation” are intended to have the same meaning in defining a layout of a UI. The determination of similarity of text elements can be based on a linguistic analysis of the text elements and based on a comparison of a structural arrangement of UI elements.

The translation information 408 of the second program can be stored in the storage medium 404, or alternatively, the translation information 408 can be received from a remote source, such as over a network to which the system of FIG. 4 is connected.

In further examples, translation information for multiple different programs can be used by the UI translation engine 402 in translating text of UI elements of the first program.

In further examples, the translation information 410 of a second program can be used to train the UI translation engine 402. In such examples, the UI translation engine 402 can be a machine learning engine that can learn over time, based on translations performed by the UI translation engine 402 itself, or based on translations performed by another UI translation engine, such as the UI translation engine for the second program. The UI translation engine 402 can be trained using translation information 410 of the second program or translation information of multiple different programs.

In some examples, correlations between the different meanings of text in a first UI element and text of another UI element (or multiple other UI elements) can be determined. Thus, for example, assume that the text of a first UI element can potentially have multiple different meanings. The UI translation engine 402 can compute a first correlation measure representing the correlation between the first meaning of the text of the first UI element and the text of the other UI element(s) related to the first UI element, compute a second correlation measure representing the correlation between the second meaning of the text in the first UI element and the other UI element(s) related to the first UI element, and so forth. The correlation measures can then be compared by the UI translation engine 402, where the highest correlation measure indicates the correct meaning of the text of the first UI element. Various correlation techniques can be employed, such as rank correlation, Pearson correlation, and so forth.

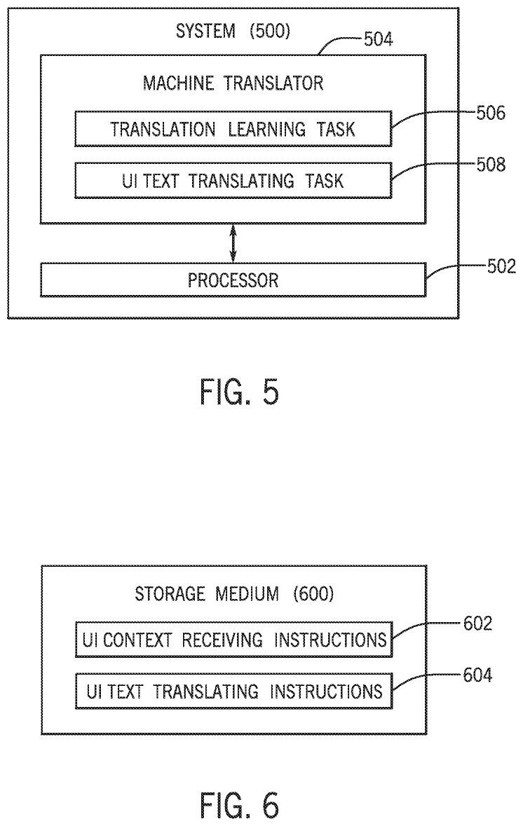

FIG. 5 is a block diagram of a system 500 including a processor 502 and a machine translator 504 executable on the processor 502 to perform various tasks. A processor can include a microprocessor, a core of a multi-core microprocessor, a microcontroller, a programmable integrated circuit, a programmable gate array, or another hardware processing circuit.

The machine translator 504 executable on the processor 502 can refer to the machine translator 504 executable on one processor or on multiple processors. The tasks of the machine translator 504 include a translation learning task 506 to learn translations of user interface (UI) elements based on translation information of a first program, the translation information comprising translations of text in UI elements of the first program from a first language to a second language. The tasks further include a UI text translating task 508 to translate, after the learning and using a user interface (UI) context of a UI of a target program, text of a UI element of the target program from the first language to the second language, the UI context identifying relationships among UI elements of the UI of the target program.

FIG. 6 is a block diagram of a non-transitory machine-readable or computer-readable storage medium 600 storing machine-readable instructions that upon execution cause a system to perform various tasks. The machine-readable instructions include UI context receiving instructions 602 to receive a UI context of a UI, the UI context identifying a relationship between UI elements of the UI. The machine-readable instructions further include UI text translating instructions 604 to translate, based on the identified relationship between the UI elements in the UI context, text in the UI from a first language to a second language.

The storage medium 600 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
receive a user interface (UI) context of a UI, the UI context identifying a relationship between UI elements of the UI; and
translate, based on the identified relationship between the UI elements in the UI context, text in the UI from a first language to a second language.

2. The non-transitory machine-readable storage medium of claim 1, wherein the identified relationship comprises a hierarchical relationship between the UI elements.

3. The non-transitory machine-readable storage medium of claim 2, wherein the hierarchical relationship between the UI elements comprises a parent-child relationship, and wherein the translated text comprises text in a first UI element of the UI elements.

4. The non-transitory machine-readable storage medium of claim 1, wherein the identified relationship comprises a sibling relationship between the UI elements of a set of the UI elements, and wherein the translated text comprises text in a first UI element of the UI elements.

5. The non-transitory machine-readable storage medium of claim 1, wherein the identified relationship comprises a spatial relationship between the UI elements, and wherein the translated text comprises text in a first UI element of the UI elements.

6. The non-transitory machine-readable storage medium of claim 1, wherein the text that is translated is part of a first UI element of the UI elements, wherein the UI context indicates a type of the first UI element, and wherein the translating is further based on the type of the first UI element.

7. The non-transitory machine-readable storage medium of claim 1, wherein the UI is for a first program, and wherein the translating is further based on translation information of a second program different from the first program, the translation information comprising translations of text in UI elements of the second program from the first language to the second language.

8. The non-transitory machine-readable storage medium of claim 1, wherein the translating is performed by a machine translator, and wherein the instructions upon execution cause the system to:
train the machine translator using translation information of a program, the translation information comprising translations of text in UI elements of the program from the first language to the second language.

9. The non-transitory machine-readable storage medium of claim 1, wherein the translating is performed by a machine translator, and wherein the instructions upon execution cause the system to:
train the machine translator using translation information of a plurality of different programs, the translation information comprising translations of text in UI elements of the plurality of programs from the first language to the second language

10. A system comprising:
a processor; and
instructions executable on the processor to:
learn translations of user interface (UI) elements based on translation information of a first program, the translation information comprising translations of text in UI elements of the first program from a first language to a second language; and
translate, after the learning and using a user interface (UI) context of a UI of a target program, text of a UI element of the target program from the first language to the second language, the UI context identifying relationships among UI elements of the UI of the target program.

11. The system of claim 10, wherein the target program is different from the first program.

12. The system of claim 10, wherein the identified relationships comprise a parent-child relationship between the UI elements of the UI of the target program, wherein the translating is based on the parent-child relationship.

13. The system of claim 10, wherein the identified relationships comprise a sibling relationship between the UI elements of the UI of the target program, wherein the translating is based on the sibling relationship.

14. The system of claim 10, wherein the identified relationships comprise a spatial relationship between the UI elements of the UI of the target program, wherein the translating is based on the spatial relationship.

15. The system of claim 14, wherein the spatial relationship is a spatial containment relationship in which a first UI element has a region that contains a second UI element.

16. The system of claim 14, wherein the spatial relationship is a proximity relationship in which a first UI element has a specified proximity to a second UI element.

17. The system of claim 10, wherein the text that is translated is part of a first UI element of the UI of the target program, and wherein the UI context identifies a type of the first UI element.

18. A method comprising:
receiving, by a machine translator in a computer system, a user interface (UI) context of a UI, the UI context identifying a relationship between UI elements of the UI; and
translating, by the machine translator based on the identified relationship in the UI context, text in the UI from a first language to a second language.

19. The method of claim 18, wherein the identified relationship comprises at least one selected from among:
a parent-child relationship between the UI elements,
a sibling relationship between the UI elements, or
a spatial relationship between the UI elements.

20. The method of claim 18, wherein the UI is for a first program, the method further comprising training the machine translator using translation information of a second program different from the first program, the translation information including information regarding translation of text for UI elements of a UI of the second program from the first language to the second language.
